(19) United States
(12) Patent Application Publication
(10) Pub. No.: US 2025/0362848 A1
(43) Pub. Date: Nov. 27, 2025

(54) SOFTWARE-BASED METHOD FOR OPERATOR GUIDANCE FOR PRINTING MACHINES

(71) Applicant: Heidelberger Druckmaschinen AG, Heidelberg (DE)

(72) Inventors: Martin Klüpfel, Hockenheim (DE); Silke Husterer, Bammental (DE); Winfried Berg, Heidelberg (DE); Sascha Epp, Sinsheim-Eschelbach (DE); Dominic Stahl, Mauer (DE); Ingo Schilz, Schriesheim (DE)

(21) Appl. No.: 19/215,651

(22) Filed: May 22, 2025

(30) Foreign Application Priority Data
May 22, 2024 (DE) 10 2024 114 244.8

(51) Int. Cl. G06F 3/12

(52) U.S. Cl. CPC G06F 3/1256; G06F 3/1203

(57) ABSTRACT

A software-based method for operator guidance in the graphics industry transmits one or more operating steps to an operator via an operator interface, in particular optically and/or acoustically, by using at least one computer. The at least one computer receives data from one or more printing orders, prepares the data of the printing orders for processing by at least one printing material processing machine and thereby calculates manual operating steps as a function of the properties of the printing material processing machine processing a printing order. The operating steps to be performed manually are optically or/and acoustically transmitted to the operator of the printing material processing machine through the operating interface with a time for performance.

### CROSS-REFERENCE TO RELATED APPLICATION

This application claims the priority, under 35 U.S.C. § 119, of German Patent Application DE 10 2024 114 244.8, filed May 22, 2024; the prior application is herewith incorporated by reference in its entirety.

### FIELD AND BACKGROUND OF THE INVENTION

The present invention relates to a software-based method for operator guidance in the graphics industry which transmits one or more operating steps to an operator via an operator interface by using at least one computer, wherein the at least one computer receives data from one or more printing orders, prepares the data of the printing orders for procession by at least one printing material processing machine and thereby calculates manual operating steps as a function of the properties of the printing material processing machine processing a printing order.

Such a software-based method for operator guidance is known from German Patent DE 10 2017 205 580 B4. That document describes a method for operating a processing machine system with at least one mobile operating unit, wherein the mobile operating unit provides machine-relevant, process-relevant or consumer material-relevant data to an operator. The mobile operating unit is able to share data or information on operating actions to be executed with the operator in sufficient time for the operator to be able to go to the location of the operating action, wherein the sharing of the operating action is carried out optically, acoustically or mechanically.

That state of the art method has the disadvantage that the operator is informed in sufficient time if he or she is to perform an operating action, but it is not shared exactly when he or she is to perform this operating action on which machine in a printing company. Therefore, that method is not suited for operator guidance in a printing company with many printing machines, folding machines and many operating personnel since a corresponding coordination is not possible due to the missing exact time indications.

### SUMMARY OF THE INVENTION

It is accordingly an object of the invention to provide a software-based method for operator guidance in the graphics industry, which overcomes the hereinafore-mentioned disadvantages of the heretofore-known methods of this general type and in which one or more even inexperienced operators are guided through upcoming manual operating steps by several printing material processing machines so that they can perform them without any problems in the correct chronological order.

With the foregoing and other objects in view there is provided, in accordance with the invention, a software-based method for operator guidance in the graphics industry which transmits one or more operating steps to an operator via an operator interface, in particular optically and/or acoustically, by using at least one computer, wherein the at least one computer receives data from one or more printing orders, prepares the data of the printing orders for processing by at least one printing material processing machine and thereby calculates manual operating steps as a function of the properties of the printing material processing machine processing a printing order, and operating steps to be performed manually are optically or/and acoustically transmitted to the operator of the printing material processing machine through the operating interface with a time for performance.

Advantageous embodiments of the present invention result from the dependent claims, the description and the figures.

The software-based method for operator guidance in the graphics industry according to the invention is realized by software which is installed on at least one computer. The computer does not have to be in a printing company, the computer can also be part of a cloud computing system on the Internet so that the software for operator guidance in the graphics industry runs in an internet cloud. It is important that the method according to the invention calculates the manual operating steps upcoming at one or more printing material processing machines so that the upcoming manual operating steps can be transmitted to the one or more operators of the printing material processing machines in one or more printing companies via an operating interface such as a screen or a speaker with a specific point in time for performance. Thus, the operator always knows exactly when he or she is to perform which manually performed operating step. In case of an optical representation on a screen, this can be in particular in a schedule such as a timeline. Not only the specific upcoming operating step is displayed to the operator, but also the place and especially the time or the current time span up to the performance of the manual operating steps. Thus, the operator can, e.g., drive a new stack of printing material from the storage to a printing machine in due time if they know that the printing material stack of the printing machine will be empty in 30 minutes. This enables a more reliable planning of the procedures especially in a large printing company with many printing material processing machines such as printing machines, folding machines etc. with many also inexperienced operators.

In a first embodiment of the present invention, it is provided that the at least one computer evaluates the data of several printing orders from a printing order queue and determines the manual operating steps across several printing orders and optically and/or acoustically transmits several manual operating steps of several printing orders with an exact time indication to the operator. In a configuration of the invention, the at least one computer evaluates the data of all printing orders present in a printing order queue and can thus precisely determine the manual operating steps with their respective times across several printing orders. Thus, it can be displayed to the operator of a printing material processing machine with an exact time or time span when they can perform which manual operating steps for the next, second-next printing order already before the next printing order is performed. This also makes planning of the manual operating steps easier for the operator and they can prepare in due time. If the processing of the planned printing orders is delayed or accomplished more quickly, the computer will detect this when processing the printing orders and will constantly update the times for performing the manual operating steps at regular, small, predefined time intervals. Thus, the times are constantly updated and the operator always optically or acoustically receives the updated times together with the corresponding manual operating steps. This is also a great advantage over the state of the art, where this permanent updating of the times or time spans up to the manual operating steps does not occur.

Advantageously, it is provided that the operating interface is a screen and/or a speaker. Thus, the operator can be acoustically and/or optically informed about the upcoming manual operating steps. The next upcoming operating steps can be displayed chronologically on a screen and certain particularly important or critical operating steps can also be highlighted in color.

In a further embodiment of the present invention, it is provided that printing orders in a printing order queue for several printing material processing machines are supplied to the at least one computer so that the at least one computer calculates the manual operating steps for several printing material processing machines and transmits them optically and/or acoustically to the respective operator of the respective printing material processing machine with the corresponding time indication for performing the operating steps. Especially in large printing companies, there are many printing machines, folding machines and other machines for printing post-processing. Each of these machines must be operated and the necessary manual operating steps must be performed at the correct time as otherwise the operation of the respective printing material processing machine will come to a standstill. In particular, folding machines and other machines for printing post-processing cannot process their planned orders if the printing machines have not processed their printing orders in time. With the present invention, it is now possible for the first time for the operator of all printing material processing machines involved in a printing and post-processing process to be informed optically or acoustically of the respective necessary manual operating steps in time with the corresponding time indication for performance. Thus, all operators of all machines in a printing company are able to constantly keep an eye on their updated manual operating steps and perform them correctly according to the shared time specifications.

Advantageously, it is also provided that data on qualifications, skills and authorized activities of the operator are supplied to the at least one computer and that the at least one computer calculates the operating steps to be performed manually as a function of the supplied data for the respective operator and assigns them to the respective operator accordingly and displays them optically and/or acoustically via the respective operating interface. In this advantageous configuration of the present invention, it is possible to calculate and also assign the operating steps to be performed manually as a function of the properties assigned to an operator. This avoids assigning complicated manual operating steps to an operator who has only limited training and qualifications, which they cannot perform or can only perform inadequately. Thus, each operator on a printing material processing machine can be assigned the operating steps that are appropriate for their qualifications and training. In particular, when employing differently qualified personnel in a printing company, each operator can be assigned the manual operating steps that they can perform without any problems. For this purpose, each operator identifies himself when approaching a printing material processing machine, e.g. with an electronic identifier such as an RFID chip or by facial recognition, so that the operating unit of the printing material processing machine can reliably recognize which operator it is dealing with. This ensures that no unqualified operator is assigned manual operating steps that they cannot execute reliably.

Advantageously, it is also provided that the at least one computer calculates conflicts due to simultaneous manual operating steps when planning several printing orders on several printing material processing machines and avoids them by cross-machine planning of the printing orders on several printing material processing machines. Since the at least one computer knows all upcoming printing orders in the printing company, it can reliably avoid conflicts and thus machine downtime. If, for example, there are not enough operating personnel available in the printing company for the simultaneous execution of manual operating steps, the at least one computer can decongest the corresponding manual operating steps in time by bringing the operating steps forward on some machines and postponing them on some machines. For this purpose, the computer can also make corresponding specifications for changing the machine speed in order to enable this decongestion in time.

Advantageously, it is further provided that the at least one computer deletes manual operating steps from the operator interface which are acknowledged by an operator or recognized as performed by a sensor in the printing material processing machine. In this configuration of the invention, the operator can acknowledge a manually performed operating step as performed, e.g. via a corresponding touch-sensitive control panel on the screen which displays the manual operating steps to them. The at least one computer then deletes the acknowledged operating step from the list of the manual operating steps to be processed. Alternatively, performed manual operating steps such as inserting a printing plate can also be recognized by a sensor such as a printing plate sensor in the machine and, if the printing plate is inserted correctly, the corresponding manual operating step can be deleted from the list of the operator interface.

Other features which are considered as characteristic for the invention are set forth in the appended claims.

Although the invention is illustrated and described herein as embodied in a software-based method for operator guidance for printing machines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic and block diagram showing the components inside and outside of a printing company required for the implementation of the method according to the invention; and

FIG. 2 is an illustration of a list with upcoming manual operating steps on a screen of a printing machine.

### DETAILED DESCRIPTION OF THE INVENTION

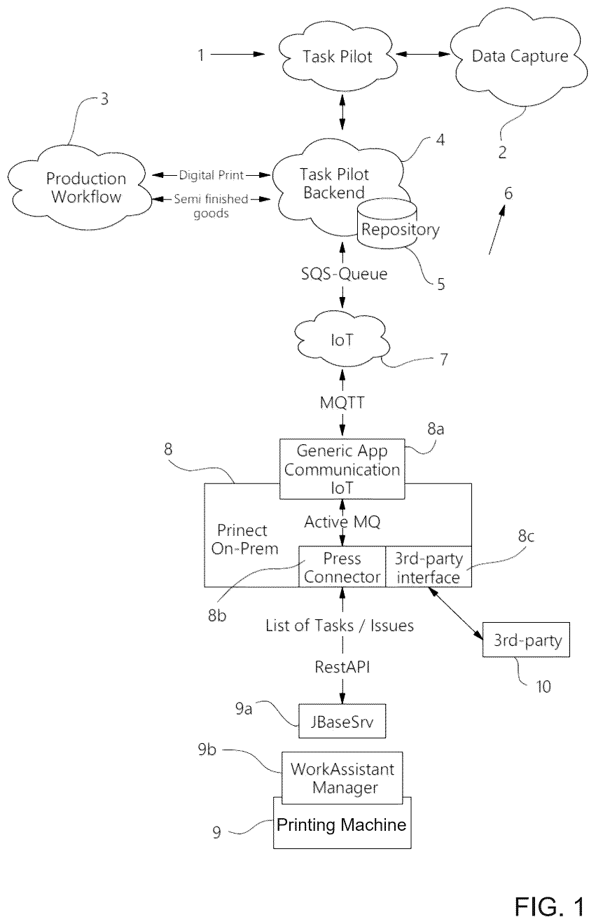

Referring now to the figures of the drawings in detail and first, particularly, to FIG. 1 thereof, there is seen an overview of the components involved in the method according to the invention. A task pilot 1, which runs in a software cloud 6, is the key element. The task pilot 1 serves to capture the data of the printing orders to be processed from a production workflow software 3 and integrate further required data via the data capture 2. The task pilot 1 has a task pilot backend 4 which stores the data of the printing orders from the production workflow software 3 in a repository 5. Further, the task pilot 1 communicates with a further cloud software in the Internet of Things 7 via the backend 4. Communication is via a SQS queue. The cloud of the Internet of Things 7, on the other hand, is connected to a precursor software server 8 in a printing company via a MQTT interface. For this purpose, the precursor software server 8 is linked to the Internet. The precursor software server 8 is usually placed in the respective printing company and has an interface to the Internet of Things 8a. Further, the precursor software server 8 has a printing machine interface 8b via which the precursor software server 8 sends the data prepared for printing to the operating system of a printing machine 9 via a Java server 9a. The printing machine 9 has a screen for operator support 9b via which the operator can operate the printing machine 9. At the same time, this screen for operator support 9b can be used to display the manual operating steps calculated by the task pilot 1 in the cloud 6 in the correct order and at the correct times. Thus, the operator of the printing machine 9 is constantly kept up to date on when he or she is to perform which manual operating steps.

The precursor software server 8 also has an interface 8c for third-party software via which third-party software 10 can be integrated. FIG. 1 explains the method according to the invention using the example of a printing machine 9, but in principle, any number of printing machines 9 and other printing material processing machines such as post-processing devices and folding machines can be integrated. Since the task pilot 1 runs in the cloud 6, it can also be used to calculate manual operating steps for a large machine park in several printing companies. The only important thing is that the task pilot 1 is supplied with the required data for upcoming printing orders via the data capture 2 and the production workflow 3 so that the task pilot 1 can calculate in advance the manual operating steps required for processing the printing orders and display them on the screen 9b of the respective printing machine 9 with a corresponding time to the operator working there.

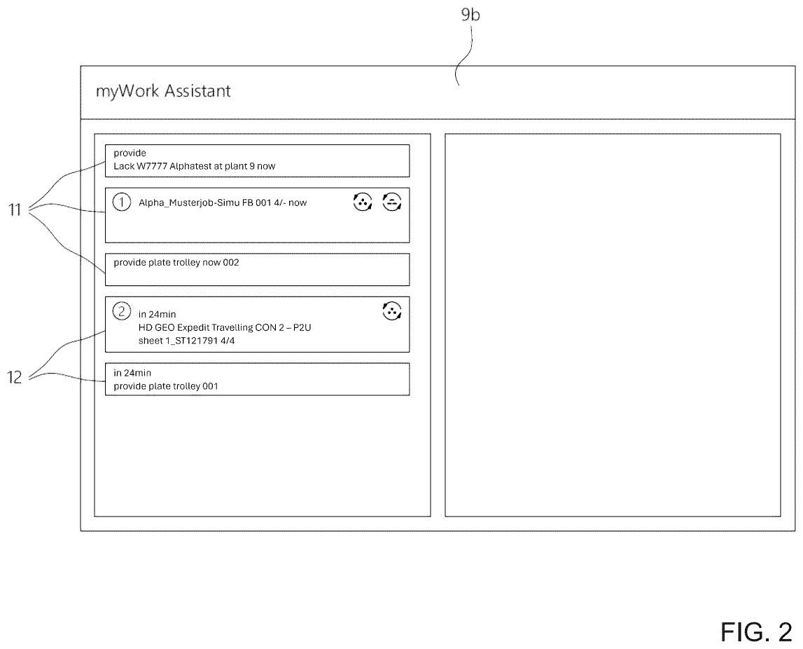

FIG. 2 shows the representation of the manual operating steps on the screen 9b. It can be recognized that there are generally two different types of manual operating steps. There are manual operating steps 11 which are now upcoming for immediate processing by the operator. These operating steps are correspondingly indicated with “now” and displayed accordingly on the screen 9b. Other operating steps are marked with the corresponding time or time span at which they should be executed, e.g. “in 24 minutes.” These operating steps 12 marked with a time are displayed to the operator in such a timely manner that he or she is able to also perform them at the displayed time. Suitably, the manual operating steps 11, 12 are displayed in the chronological performance order.

The task pilot 1 is preferably equipped with artificial intelligence so that they can permanently learn from the printing orders and situations occurring on the printing machines 9 and can take them into account in the future when calculating the times of the manual operating steps 11, 12.

The following is a summary list of reference numerals and the corresponding structure used in the above description of the invention:
1 task pilot
2 data capture
3 production workflow software
4 task pilot backend
5 repository
6 cloud
7 Internet of Things
8 precursor software server
8a interface to Internet of Things
8b printing machine interface
8c interface for third-party software
9 printing machine
9a Java based server
9b screen for operator support
10 third-party software
11 tasks to be done immediately
12 tasks in the future with time indication

1. A software-based method for operator guidance in the graphics industry, the method comprising:
using at least one computer to at least one of optically or acoustically transmit one or more operating steps to be performed manually to an operator of at least one printing material processing machine through an operator interface with a time for performance; and
using the at least one computer to receive data from one or more printing orders, to prepare the data of the one or more printing orders for processing by the at least one printing material processing machine and to thereby calculate manual operating steps as a function properties of the at least one printing material processing machine processing a printing order.

2. The method according to claim 1, which further comprises using the at least one computer to evaluate the data of a plurality of the printing orders from a printing order queue, to determine the manual operating steps across the plurality of printing orders and to at least one of optically or acoustically transmit the manual operating steps of the plurality of printing orders with an exact time indication to the operator.

3. The method according to claim 1, which further comprises providing at least one of a screen or a speaker as the operating interface.

4. The method according to claim 1, which further comprises supplying the one or more printing orders in a printing order queue for a plurality of the printing material processing machines to the at least one computer, and using the at least one computer to calculate the manual operating steps for a plurality of the printing material processing machines and to transmits the manual operating steps at least one of optically or acoustically to a respective operator of a respective printing material processing machine with a corresponding time indication for performing the operating steps.

5. The method according to claim 1, which further comprises supplying data regarding qualifications, skills and authorized activities of the operator to the at least one computer, and using the at least one computer to calculate the operating steps to be performed manually as a function of the supplied data for a respective operator, to accordingly assign the operating steps to the respective operator and to display the operating steps at least one of optically or acoustically through a respective operating interface.

6. The method according to claim 1, which further comprises using the at least one computer to calculate conflicts due to simultaneous manual operating steps when planning a plurality of printing orders on a plurality of printing material processing machines and to avoid the conflicts by cross-machine planning of the plurality of printing orders on the plurality of printing material processing machines.

7. The method according to claim 1, which further comprises providing the at least one computer as part of a cloud computer system.

8. The method according to claim 1, which further comprises using the at least one computer to delete from the operator interface manual operating steps acknowledged by an operator or recognized as performed by a sensor in the printing material processing machine.

9. The method according to claim 1, which further comprises using the at least one computer to regularly recalculate times of the upcoming manual operating steps and to send the times updated to the operator interface.
